(19) United States
(12) Patent Application Publication
(10) Pub. No.: US 2015/0302022 A1
(43) Pub. Date: Oct. 22, 2015

(54) DATA DEDUPLICATION METHOD AND APPARATUS

(71) Applicant: SAMSUNG ELECTRONICS CO., LTD., Suwon-si (KR)

(72) Inventors: Bon-Cheol GU, Seongnam-si (KR); Ju-Pyung LEE, Suwon-si (KR)

(21) Appl. No.: 14/688,076

(22) Filed: Apr. 16, 2015

(30) Foreign Application Priority Data
Apr. 21, 2014 (KR) 10-2014-0047450

(51) Int. Cl. G06F 17/30

(52) U.S. Cl. CPC G06F 17/30159; G06F 17/30336

(57) ABSTRACT

A data deduplication method includes separating data into a plurality of data chunks that correspond to first to N-th positions, N being a positive integer that is greater than 1; determining discrimination indexes of the first to N-th positions, respectively; arranging the order of the first to N-th positions according to values of the discrimination indexes; recording the arranged order of the first to N-th positions on a position vector; and generating fingerprints through combination of the data chunks that correspond to the first to N-th positions according to the order of the first to N-th positions recorded on the position vector, wherein the determining discrimination indexes includes determining the discrimination indexes according to a ratio of duplicate data chunks to the data chunks that correspond to a same position in a plurality of pieces of data.

### CROSS-REFERENCE TO RELATED APPLICATIONS

This application is based on and claims priority from Korean Patent Application No. 10-2014-0047450, filed on Apr. 21, 2014 in the Korean Intellectual Property Office, the disclosure of which is incorporated herein in its entirety by reference.

### BACKGROUND

1. Field

One or more example embodiments of the inventive concepts relate to a data deduplication method and a data deduplication apparatus.

2. Description of the Prior Art

With the development of the performance of a computer system including a distributed storage system, the scale of data that is processed in the computer system is also increased, and problems may occur in securing a storage space of the data. In particular, it costs a lot to expand equipment so as to secure the storage space in the distributed storage system that stores large-scale data, and thus it is necessary to reduce wasted storage space through an efficient operation of given storage space. For this, there has been a need for various schemes for processing duplicate data having the same contents during data management.

### SUMMARY

At least one example embodiment of the inventive concepts provides a data deduplication method that removes duplicate data using a finger print.

At least one example embodiment of the inventive concepts provides a data deduplication apparatus that removes duplicate data using a fingerprint.

Additional advantages, subjects, and features of one or more example embodiments of the inventive concepts will be set forth in part in the description which follows and in part will become apparent to those having ordinary skill in the art upon examination of the following or may be learned from practice of one or more example embodiments of the inventive concepts.

According to one or more example embodiments of the inventive concepts, a data deduplication method includes separating data into a plurality of data chunks that correspond to first to N-th positions, N being a positive integer that is greater than 1; determining discrimination indexes of the first to N-th positions, respectively; arranging the order of the first to N-th positions according to values of the discrimination indexes; recording the arranged order of the first to N-th positions on a position vector; and generating fingerprints through combination of the data chunks that correspond to the first to N-th positions according to the order of the first to N-th positions recorded on the position vector, wherein the determining discrimination indexes includes determining the discrimination indexes according to a ratio of duplicate data chunks to the data chunks that correspond to the same position in a plurality of pieces of data.

According to one or more example embodiments of the inventive concepts, a data deduplication method includes separating data, for which a storage operation is requested, into a plurality of data chunks that correspond to first to N-th positions, respectively, N being a positive integer greater than 1; determining discrimination indexes of the first to N-th positions, respectively; arranging the order of the first to N-th positions according to values of the discrimination indexes; recording the arranged order of the first to N-th positions on a position vector; and generating fingerprints through combination of the data chunks that correspond to the first to N-th positions according to the order of the first to N-th positions recorded on the position vector, wherein the determining discrimination indexes includes determining the discrimination indexes according to a ratio of duplicate data chunks to the data chunks that correspond to the same position in a plurality of pieces of data, and a length of the fingerprints is varied according to a state of a storage unit in which the plurality of pieces of data are stored.

According to one or more example embodiments, a data deduplication method includes separating each of a plurality of data units into first to N-th data chunks, the first to N-th data chunks being in first to N-th data positions, respectively, N being a positive integer that is greater than 1; determining first to N-th discrimination indexes corresponding to the first to N-th data positions, respectively, such that, for each of the first to N-th discrimination indexes, the discrimination index represents a degree of discrimination among first data chunks, first data chunks being data chunks, from among the first to N-th data chunks of the plurality of data units, that are in the data position to which the discrimination index corresponds; arranging the order of the first to N-th positions according to values of the discrimination indexes; storing the arranged order of the first to N-th positions as a position vector; generating a plurality of fingerprints based on the position vector; and determining whether a data unit is a duplicate of one of the plurality of data units based on the plurality of fingerprints.

### BRIEF DESCRIPTION OF THE DRAWINGS

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a schematic diagram explaining a distributed storage device that performs a data deduplication method according to at least one example embodiment of the inventive concepts;

FIG. 2 is a schematic diagram explaining a data deduplication apparatus according to at least one example embodiment of the inventive concepts;

FIG. 3 is a schematic diagram explaining a data deduplication method according to at least one example embodiment of the inventive concepts;

FIG. 4 is a schematic view explaining generation of position vectors according to a data deduplication method according to at least one example embodiment of the inventive concepts;

FIG. 5 is a schematic view explaining generation of a fingerprint using position vectors explained with reference to FIG. 4 according to a data deduplication method according to at least one example embodiment of the inventive concepts;

FIG. 6 is a schematic view explaining a data deduplication method according to at least one example embodiment of the inventive concepts;

FIG. 7 is a schematic view explaining a data deduplication method according to still at least one example embodiment of the inventive concepts;

FIG. 8 is a schematic view explaining a data deduplication method according to still at least one example embodiment of the inventive concepts;

FIG. 9 is a flowchart explaining a data deduplication method according to at least one example embodiment of the inventive concepts;

FIG. 10 is a flowchart explaining a data deduplication method according to at least one example embodiment of the inventive concepts;

FIG. 11 is a schematic block diagram explaining an electronic system that includes a semiconductor device according to at least one example embodiment of the inventive concepts; and

FIG. 12 is a schematic block diagram explaining an application example of a storage system that includes a semiconductor device according to at least one example embodiment of the inventive concepts.

### DETAILED DESCRIPTION OF THE EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Accordingly, while example embodiments of the inventive concepts are capable of various modifications and alternative forms, embodiments thereof are shown by way of example in the drawings and will herein be described in detail. It should be understood, however, that there is no intent to limit example embodiments of the inventive concepts to the particular forms disclosed, but to the contrary, example embodiments of the inventive concepts are to cover all modifications, equivalents, and alternatives falling within the scope of example embodiments of the inventive concepts. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the inventive concepts are described herein with reference to schematic illustrations of idealized embodiments (and intermediate structures) of the inventive concepts. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

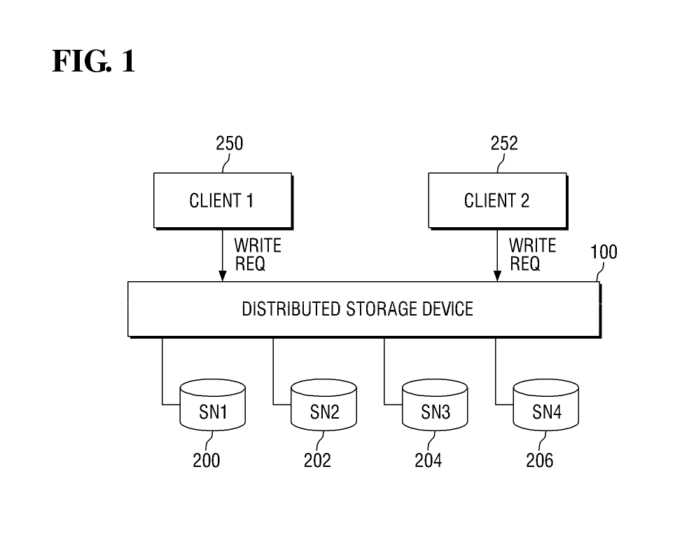

FIG. 1 is a schematic diagram explaining a distributed storage device that performs a data deduplication method according to at least one example embodiment of the inventive concepts.

Referring to FIG. 1, a distributed storage device 100 that performs a data deduplication method according to at least one example embodiment of the inventive concepts performs a data input/output operation through reception of a data input/output request from one or more clients 250 and 252. For example, the distributed storage device 100 may store data, for which a write operation is requested by the one or more clients 250 and 252, in one or more storage nodes 200, 202, 204, and 206 in a distributed manner, and may read data, for which a read operation is requested by the one or more clients 250 and 252, from the one or more storage nodes 200, 202, 204, and 206 to transmit the read data to the clients 250 and 252.

In one or more example embodiments of the inventive concepts, the distributed storage device 100 may include a processor and may be a single server or a multi-server, and the distributed storage device 100 may further include a metadata management server that manages metadata for the data stored in the storage nodes 200, 202, 204, and 206. Each of the clients 250 and 252 is a terminal that may include a processor and can access the distributed storage device 100 through a network, and includes, for example, a computer, such as a desk-top computer or a server, or a mobile device, such as a cellular phone, a smart phone, a tablet PC, a notebook computer, or a PDA (Personal Digital Assistants), but is not limited thereto. Each of the storage nodes 200, 202, 204, and 206 may be, but is not limited to, a storage device, such as a HDD (Hard Disk Drive), a SSD (Solid State Drive), or a NAS (Network Attached Storage), and may include one or processing units or processors. The clients 250 and 252, the distributed storage device 100, and the storage nodes 202, 202, 204, and 206 may be connected to each other through a wire network, such as LAN (Local Area Network), or WAN (Wide Area Network), or a wireless network, such as Wi-Fi, Bluetooth, or cellular network.

The term ‘processor’, as used herein, may refer to, for example, a hardware-implemented data processing device having circuitry that is physically structured to execute desired operations including, for example, operations represented as code and/or instructions included in a program. Examples of the above-referenced hardware-implemented data processing device include, but are not limited to, a microprocessor, a central processing unit (CPU), a processor core, a multiprocessor, an application-specific integrated circuit (ASIC), and a field programmable gate array (FPGA).

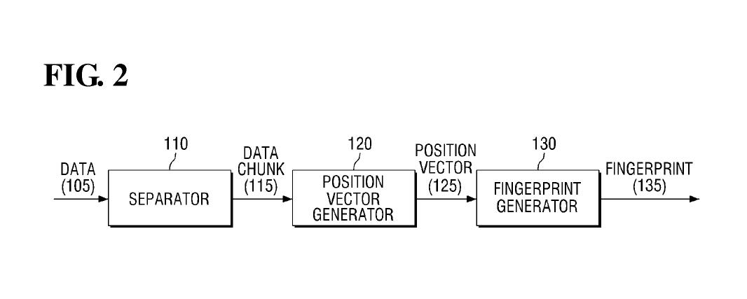

FIG. 2 is a schematic diagram explaining a data deduplication apparatus according to at least one example embodiment of the inventive concepts.

Referring to FIG. 2, a data deduplication apparatus according to at least one example embodiment of the inventive concepts may include a separator 110, a position vector generator 120, and a fingerprint generator 130.

The separator 110 separates data 105 into a plurality of data chunks 115. For example, in one or more example embodiments of the inventive concepts, the separator 110 may separate the data 105 for which a write operation is requested by the clients 250 and 252 into the plurality of data chunks. The divided data chunks 115 may correspond to first to N-th (where, N is a natural number) positions. For example, among the plurality of data chunks 115 divided from the data 105, the first data chunk may correspond to the first position, the second data chunk may correspond to the second position, and the N-th data chunk may correspond to the N-th position. The first to N-th positions are not inherent to specific data. That is, such positions are also applied to any data stored in the storage together with the data 105. For example, other data stored in the storage together with the data 105 may be separated into a plurality of data chunks, and the separated data chunks may exist through the first to N-th positions.

The position vector generator 120 calculates discrimination indexes of the first to N-th positions that correspond to the positions of the plurality of data chunks 115, arranges the order of the first to N-th positions according to values of the discrimination indexes, and records the arranged order of the first to N-th positions on position vectors 125.

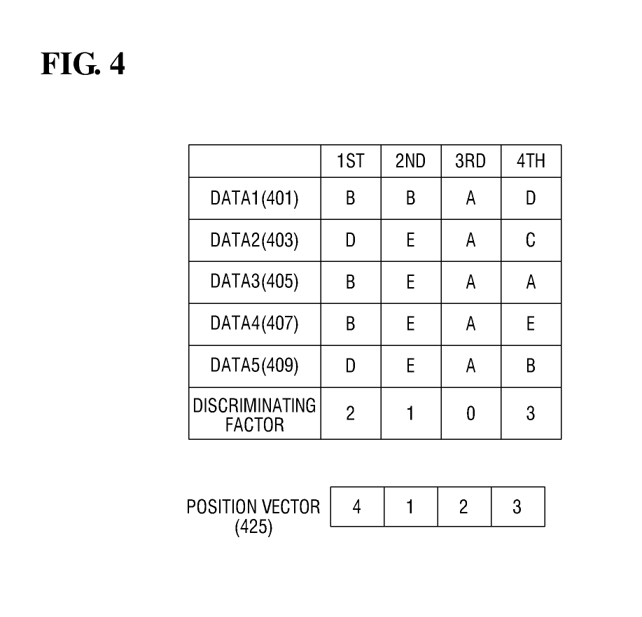

The discrimination index indicates the degree of discrimination of the whole data with a part of the data chunks. For example, if it is assumed that two pieces of data (A, B) and (A, C) are stored in the storage (here, A, B, and C mean data chunks or symbols), the data chunks or symbols that are at the first position are equally A, and thus the two pieces of data are unable to be discriminated from each other. However, the data chunks or symbols that are at the second position are differently B and C, and thus the two pieces of data can be discriminated from each other. That is, the second position at which B and C are positioned has higher discrimination than the discrimination of the first position, and thus a higher discrimination index can be given to the second position than the first position, where high or higher discrimination, as used herein with reference to data positions, refers to a greater degree of difference between data (i.e. chunks of data) at a given position than the degree of difference between data at a position that has than low or lower discrimination. In relation to this, the details of the method for giving a discrimination index will be described later with reference to FIG. 4.

That is, the position vector generator 120 may calculate the discrimination indexes of the first to N-th positions that correspond to the positions of the plurality of data chunks 115, and may give a large discrimination index value to the position having high discrimination, and a give low discrimination index value to a position having low discrimination. Unlike this, in some one or more example embodiments of the inventive concepts, a small discrimination index value may be given to the position having high discrimination, and a high discrimination index value may be given to the position having low discrimination. After all the discrimination indexes for the first to N-th positions are determined, the position vector generator 120 arranges the order of the first to N-th positions according to the discrimination index values. For example, in the case where the discrimination index value is set to become larger as the discrimination becomes higher, the first to N-th positions may be arranged in descending order of discrimination index. By contrast, in the case where the discrimination index value is set to become smaller as the discrimination becomes higher, the first to N-th positions may be arranged in ascending order of discrimination index. That is, the first to N-th positions may be arranged in the order of their discrimination. Thereafter, the position vector generator 120 records the arranged order of the first to N-th positions on the position vectors 125. Here, the position vector 125 has a plurality of elements which indicate the first to N-th positions, and the order of the elements corresponds to the arranged order of the first to N-th positions. For example, a position vector (4, 1, 2, 3) indicates that the order of the first through forth positions from highest level of discrimination to lowest level of discrimination is: the fourth position, the first position, the second position, and the third position.

The fingerprint generator 130 generates a fingerprint through combination of data chunks that correspond to the first to N-th positions. For example, if a position vector is (4, 1, 2, 3), the fingerprint may be generated through combination in order of data chunks that correspond to the fourth position, the first position, the second position, and the third position. In one or more example embodiments of the inventive concepts, the position vector may be generated as a vector having N elements that include the all first to N-th positions. Here, the fingerprint generation unit 130 acquires only M (where, M is a natural number that is smaller than N) elements among the elements of the position vector, and based on this, the fingerprint can be generated through combination of M data chunks.

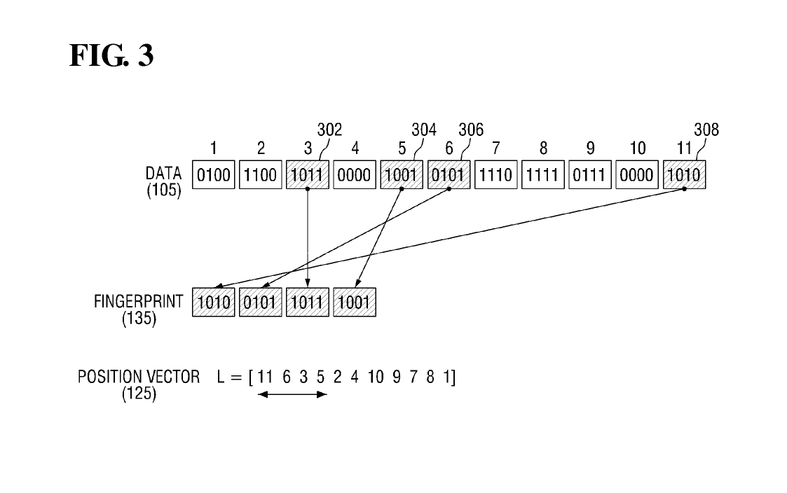

FIG. 3 is a schematic diagram explaining a data deduplication method according to at least one example embodiment of the inventive concepts.

Referring to FIG. 3, according to the data deduplication method according to at least one example embodiment of the inventive concepts, data 105 is separated into a plurality of data chunks, and the separated data chunks correspond to the first to eleventh positions. If it is determined that the order of the levels of discrimination of the eleven positions from highest to lowest is: the eleventh position, the sixth position, the third position, the fifth position, etc., as the result of calculating the discrimination indexes for the first to eleventh positions through the position vector generator 120, a position vector 125 of (11, 6, 3, 5, 2, 4, 10, 9, 7, 8, 1) may be generated through arrangement of the order of the first to eleventh positions according to discrimination index values. Next, the fingerprint generator 130 acquires only four initial elements of the position vector, and based on this, a fingerprint 135 may be generated through combination of four data chunks that correspond to (11, 6, 3, 5) of the position vector 125. That is, the fingerprint generator 130 may generate a fingerprint 135 through combination of the data chunk 308 that corresponds to the eleventh position, the data chunk 306 that corresponds to the sixth position, the data chunk 302 that corresponds to the third position, and the data chunk 304 that corresponds to the fifth position.

FIG. 4 is a schematic view explaining generation of position vectors according to a data deduplication method according to at least one example embodiment of the inventive concepts.

Referring to FIG. 4, data may be arranged in plural pieces (or data units) 401, 403, 405, 407, and 409. Further, each piece of data 401, 403, 405, 407, and 409 may be separated into four data chunks. In FIG. 4, the data chunks are represented by symbols, such as A, B, C, and D. Four data chunks that are separated from each piece of data 401, 403, 405, 407, and 409 may correspond to the first to fourth positions. For example, the first data chunks B, D, B, B, and D that are respectively separated from the data 401, 403, 405, 407, and 409 may correspond to the first position, and the second data chunks B, E, E, E, and E that are respectively separated from the data 401, 403, 405, 407, and 409 may correspond to the second position. In the same manner, the third data chunks A, A, A, A, and A that are respectively separated from the data 401, 403, 405, 407, and 409 may correspond to the third position, and the fourth data chunks D, C, A, E, and B that are respectively separated from the data 401, 403, 405, 407, and 409 may correspond to the fourth position.

As for the first-through fourth positions of the data 401, 403, 405, 407, and 409, the fourth position has the highest discrimination. That is, without the necessity of considering the data chunks that correspond to other positions (i.e., first to third positions), the data 401, 403, 405, 407, and 409 can be discriminated only by the data chunks D, C, A, E, and B that correspond to the fourth position. On the other hand, the third position has the lowest discrimination. That is, the data chunks that correspond to the fourth position are equal to each other (because all are A), and thus, it is not possible to discriminate the data 401, 403, 405, 407, and 409 only by the data chunks that correspond to the third position. As a result, in this embodiment, it can be known that the order of the positions, in terms of descending discrimination, is: the fourth position, the first position, the second position, and the third position. Accordingly, discrimination indexes of 3, 2, 1, and 0 may be respectively given to the fourth position, the first position, the second position, and the third position to indicate the order of the first to fourth positions.

That is, the discrimination indexes may be determined according to the ratio of duplicate data chunks to the data chunks that correspond to the same position. In some one or more example embodiments of the inventive concepts, the discrimination index may be set to be higher as the ratio of the duplicate data chunks becomes lower, and the discrimination index may be set to be lower as the ratio of the duplicate data chunks becomes higher. For example, if the number of duplicate data chunks among the data chunks that correspond to the fourth position is smaller than the number of duplicate data chunks among the data chunks that correspond to the first position in a plurality of pieces of data, the discrimination index of the fourth position may be higher than the discrimination index of the first position.

On the other hand, in one or more example embodiments of the inventive concepts, the discrimination index may be expressed in figure, character, and other data structures that can display the priority, but is not limited to any specific expression type. Further, in one or more example embodiments of the inventive concepts, the discrimination index may be expressed as a relative value between the first to fourth positions, or may be expressed as an absolute value that can be globally applied. According to the order of discrimination index values as calculated above, the position vector 425 records the order of the first to fourth positions. That is, the position vector 425 may be expressed as (4, 1, 2, 3).

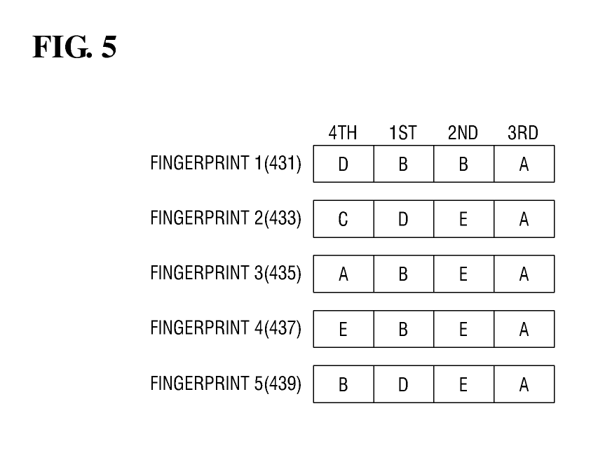

FIG. 5 is a schematic view explaining generation of a fingerprint using position vectors explained with reference to FIG. 4 according to a data deduplication method according to at least one example embodiment of the inventive concepts.

Referring to FIG. 5, fingerprints 431, 433, 435, 437, and 439 are generated from the data 401, 403, 405, 407, and 409 using the position vector 425. Specifically, the fingerprint 431 is generated through combination of the data chunk D that corresponds to the fourth position, the data chunk B that corresponds to the first position, the data chunk B that corresponds to the second position, and the data chunk A that corresponds to the third position on the basis of (4, 1, 2, 3), the position vector 425. In the same manner, the fingerprint 433 is generated through combination of the data chunk C that corresponds to the fourth position, the data chunk D that corresponds to the first position, the data chunk E that corresponds to the second position, and the data chunk A that corresponds to the third position on the basis of (4, 1, 2, 3) of the position vector 425. In order to determine whether there is any duplicate data between the data 401, 403, 405, 407, and 409, the fingerprints 431, 433, 435, 437, and 439 as generated above make it possible to rapidly determine whether the data 401, 403, 405, 407, and 409 are equal to each other.

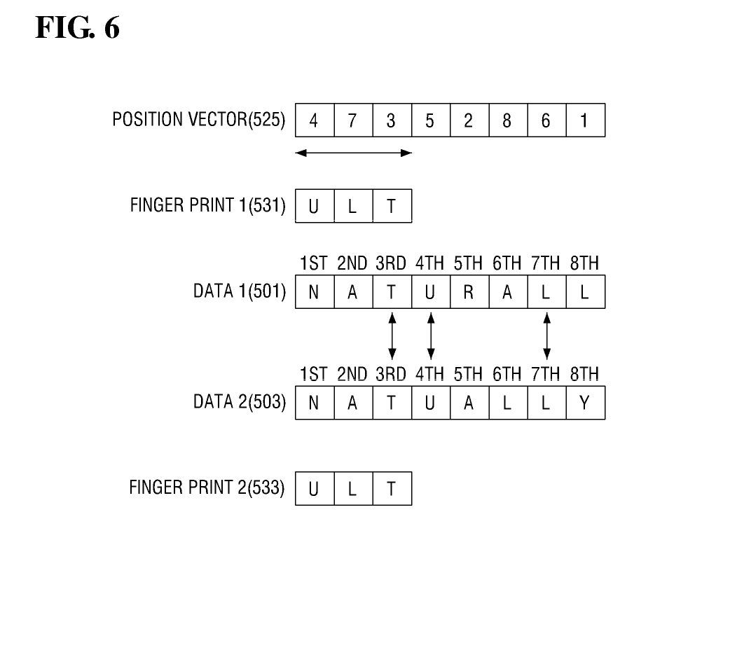

FIG. 6 is a schematic view explaining a data deduplication method according to at least one example embodiment of the inventive concepts.

Referring to FIG. 6, it may be determined through comparison of fingerprints 531 and 533 with each other based on a position vector 525 whether data 501 and 503 are duplicate data. In this embodiment, the data 501 and 503 may be separated into 8 data chunks that correspond to first to eighth positions. Next, the position vector 525, (4, 7, 3, 5, 2, 8, 6, 1), may be constructed through calculation of discrimination indexes of the first to eighth positions according to the above-described discrimination index calculation method. Here, it is assumed that the fingerprint generator 130 acquires only three of elements of the position vector 525 to generate the fingerprints 531 and 533. Through this, the fingerprint 531 is formed through combination of a data chunk U at the fourth position, a data chunk L at the seventh position, and a data chunk T at the third position. The fingerprint 533 is also formed through combination of U, L, and T in the order of the fourth position, the seventh position, and the third position. However, in this embodiment, since the fingerprints 531 and 532 are formed in the same manner, the data 501 and 503 are unable to be discriminated only through the fingerprints 531 and 532 that include three data chunks. In this case (in the case where collision of fingerprints 531 and 532 occurs), the identity of the data 501 and 503 may be determined in consideration of the whole position vector 525. That is, according to the order of the first to N-th positions (i.e., first to eighth positions) recorded on the position vector 525, it may be determined whether the data 501 and 502 are duplicate data through comparison of the data 501 and 503 with each other in the unit of a data chunk.

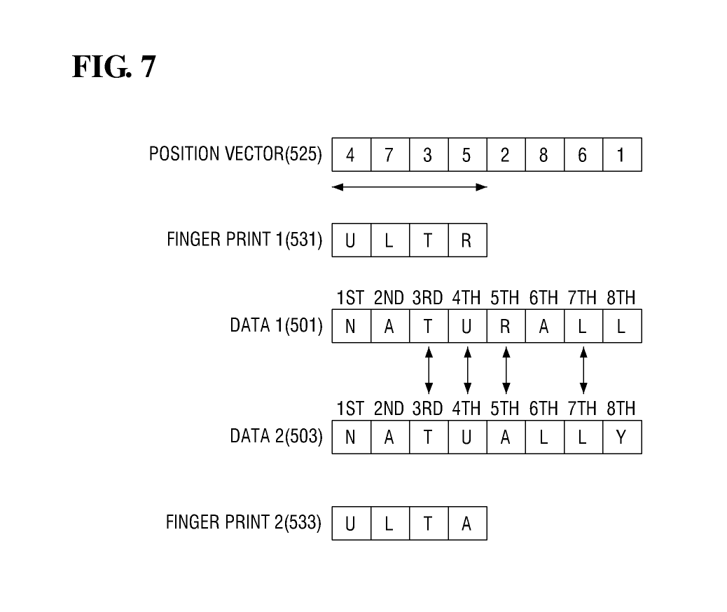

FIG. 7 is a schematic view explaining a data deduplication method according to still at least one example embodiment of the inventive concepts.

Like FIG. 6, in the case where the fingerprints 531 and 532 are formed in the same manner with respect to different data 501 and 503 (i.e., in the case where collision of fingerprints 531 and 532 occurs), the length of the fingerprints 531 and 532 may be increased on the basis of the position vector 525. Specifically, referring to FIG. 7, the fingerprint generator 130, which generates the fingerprint through acquiring of three of elements of the position vector 525, may increase its length through regeneration of the fingerprints 531 and 533 based on four of elements of the position vector 525 in total by acquiring one more element. Through this, the fingerprint 531 is formed through further combination of a data chunk A at the fifth position with a data chunk U at the fourth position, a data chunk L at the seventh position, and a data chunk T at the third position. In the same manner, the fingerprint 532 is also formed through further combination of A at the fifth position with the combination of U, L, and T in the order of the fourth position, the seventh position, and the third position. Accordingly, the data 501 and 503 may be discriminated from each other through comparison of the fingerprints 531 and 533 formed by four data chunks.

As described above, the position vector may be generated as a vector having N elements that include the entire first to N-th positions. Here, the fingerprint generator 130 may acquire only M elements of the position vector (where, M is a natural number that is smaller than N), and based on the M elements, may generate the fingerprints through combination of M data chunks. In one or more example embodiments of the inventive concepts, if the size of the data exceeds a preset upper limit value, the fingerprint generator 130 may increase the value M (i.e., may increase the length of the fingerprint). On the other hand, if the size of the data is smaller than a preset lower limit value, the fingerprint generator 130 may decrease the value M (i.e., may decrease the length of the fingerprint).

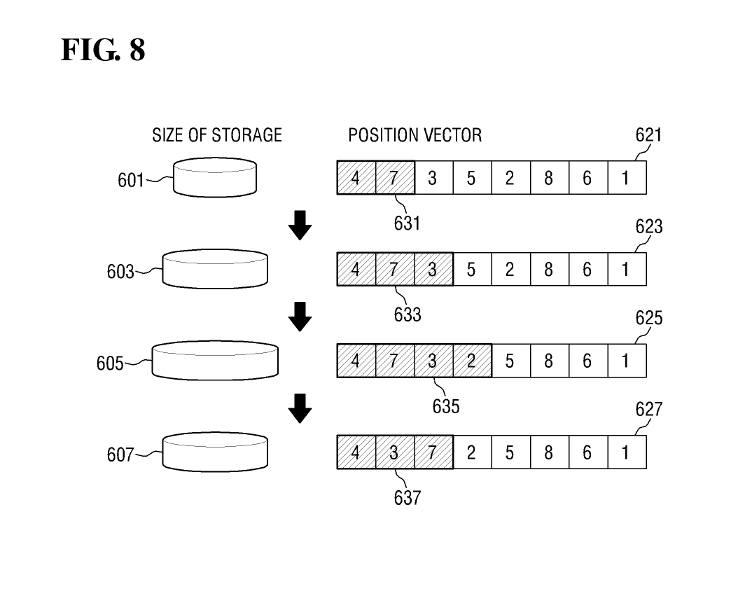

FIG. 8 is a schematic view explaining a data deduplication method according to at least one example embodiment of the inventive concepts.

Referring to FIG. 8, in a data deduplication method according to at least one example embodiment of the inventive concepts, the length of the fingerprint may be varied according to the state of a storage device or unit in which data is stored. Specifically, the fingerprint generator 130 may increase or decrease the length of the fingerprint based on the position vector 621 according to the state of the storage units 601, 603, 605, and 607. For example, the fingerprint generation unit 130 may increase the length of a fingerprint target region 631 that is the target of fingerprint generation (refer to fingerprint target region 633). In one or more example embodiments of the inventive concepts, the fingerprint generator 130 may increase the length of the fingerprint if the size of the plurality of data stored in the storage unit exceeds the preset upper limit value. On the other hand, for example, the fingerprint generator 130 may decrease the length of the fingerprint target region 635 that is the target of fingerprint generation on the position vector 625 (refer to fingerprint target region 637). In one or more example embodiments of the inventive concepts, the fingerprint generator 130 may decrease the length of the fingerprint in the above-described method if the size of the plurality of pieces of data stored in the storage unit is smaller than the preset lower limit value.

On the other hand, the position vector generator 120 may reconstruct the position vector according to the state of the storage units 601, 603, 605, and 607. Specifically, if data construction of the storage 605 is changed through deletion of a part of the data stored in the storage 605 or additional storage of data input from an outside in the storage 605, the position vector 625 may be re-calculated based on the changed storage. For example, in a scenario where storage unit 607 represents storage unit 605 after data is deleted from storage unit 605, the position vector 625 may be re-calculated as position vector 627 based on the state of storage unit 607, which, as a result of the above-referenced deletion of data, has changed from the previous state of storage unit 605. Specifically, the position vector 625, (4, 7, 3, 2, 5, 8, 6, 1), may be reconstructed as the position vector 627, (4, 3, 7, 2, 5, 8, 6, 1). That is, in the plurality of pieces of data stored in the storage unit 605, the level of discrimination at the seventh position is higher than the level of discrimination at the third position, but in the storage unit 607, the level discrimination at the seventh position may be lower than the level of discrimination at the third position, and thus the position vector may be reconstructed.

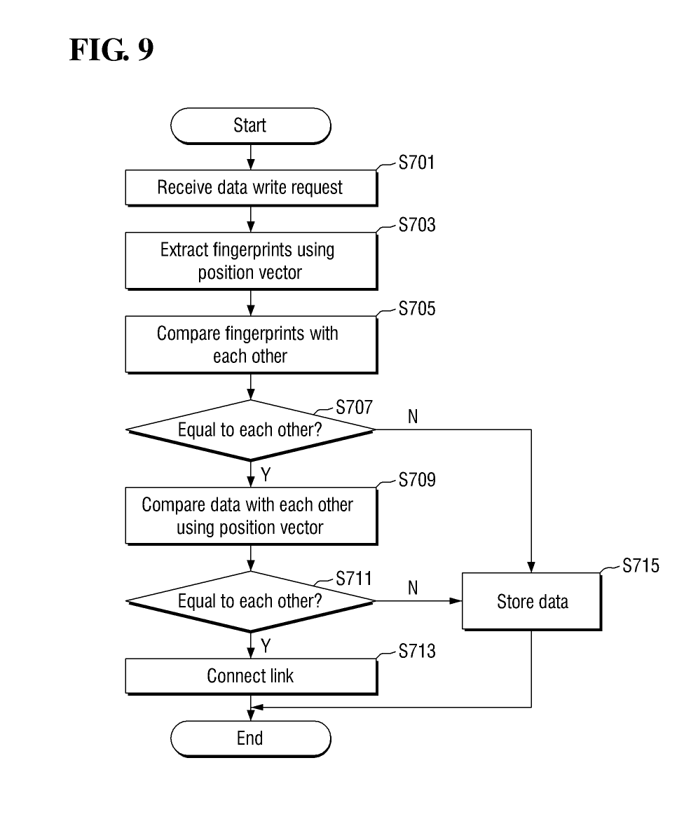

FIG. 9 is a flowchart explaining a data deduplication method according to at least one example embodiment of the inventive concepts.

Referring to FIG. 9, in a data deduplication method according to at least one example embodiment of the inventive concepts, a data write request may be received from a user or a client 250 (S701), and a fingerprint for the write-requested data may be extracted through construction of a position vector (S703). As described above, the constructing the position vector may include separating the data into a plurality of data chunks that correspond to first to N-th (where, N is a natural number) positions, and calculating discrimination indexes for the first to N-th positions. Further, the constructing the position vector may further include arranging the order of the first to N-th positions according to discrimination index values, and recording the order on the position vector. On the other hand, the extracting the fingerprint may include generating the fingerprint through combination of the data chunks that correspond to the first to N-th positions according to the order of the first to N-th positions recorded on the position vector.

Next, the data deduplication method according to at least one example embodiment of the inventive concepts may further include determining whether two or more pieces of data are duplicate data through comparison of the fingerprints of the two or more pieces of data with each other (S705). Here, the two or more pieces of data may include, for example, first data pre-stored in the storage and second data of which a write is requested. If the fingerprints of the first data and the second data are different from each other (S707-N), the second data for which a write operation is requested may be different from the first data and thus may be stored in the storage (S715). Unlike this, if the fingerprints of the first data and the second data are equal to each other (S707-Y), it may be determined whether the first data and the second data are duplicate data through comparison of the data in the unit of a data chunk according to the order of the first to N-th data recorded on the position vector (S709). If the first data and the second data are different from each other (S711-Y), the second data is not stored in the storage, and a link for the first data that is equal to the second data is generated (S713).

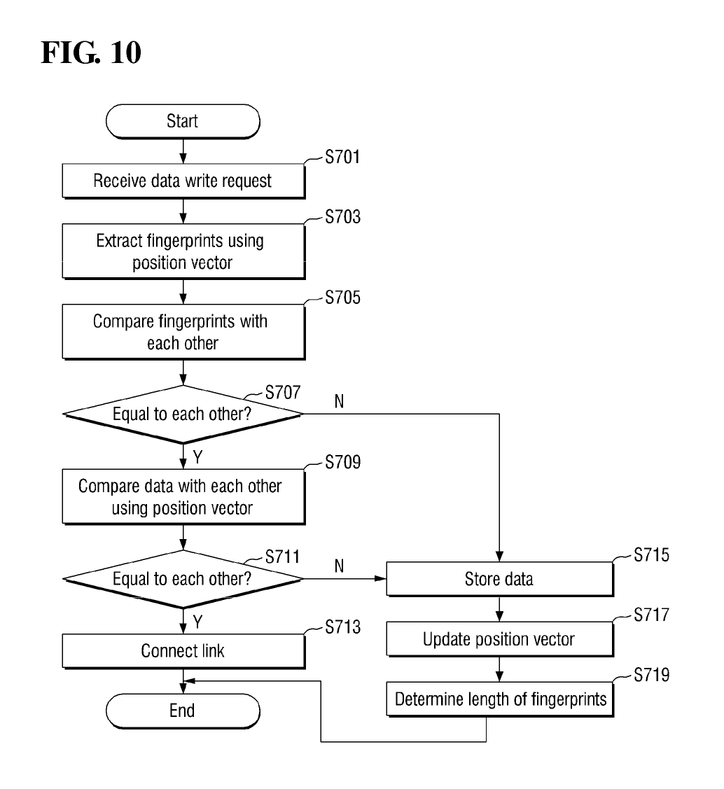

FIG. 10 is a flowchart explaining a data deduplication method according to at least one example embodiment of the inventive concepts.

Referring to FIG. 10, a data deduplication method according to at least one example embodiment of the inventive concepts includes additional steps of S717 and S719 in addition to steps of S701 and S715 as described above with reference to FIG. 9. If the fingerprints of the first data and the second data are different from each other (S707-N), the second data for which the write operation is requested may be different from the first data and thus may be stored in the storage (S715). If the second data is stored in the storage, it may be necessary to re-calculate the discrimination indexes calculated on the basis of the existing data stored in the storage. In this case, the data deduplication method according to this embodiment may update the position vector through reflection of the state of the storage in which the second data is additionally stored (S717). Further, as the second data is stored in the storage, it may be necessary to adjust the length of the fingerprint calculated on the basis of the existing data stored in the storage. In this case, the data deduplication method according to this embodiment may increase or decrease the length of the fingerprint through reflection of the state of the storage in which the second data is additionally stored.

According to one or more example embodiments of the inventive concepts, in the case of comparing the fingerprints of the data to perform data deduplication, data chunks having high discrimination between the data are preferentially compared with each other. Accordingly, it is possible to rapidly determine whether the data are equal to each other and the number of commands for identity determination can be reduced to achieve effective work.

Further, the fingerprint is generated using a part of the data (i.e., separated data chunks) as it is, and if the fingerprints of the two data are similar to each other, it can be expected that the corresponding data themselves are similar to each other. Using this, it becomes possible to determine not only the same data but also the similar data.

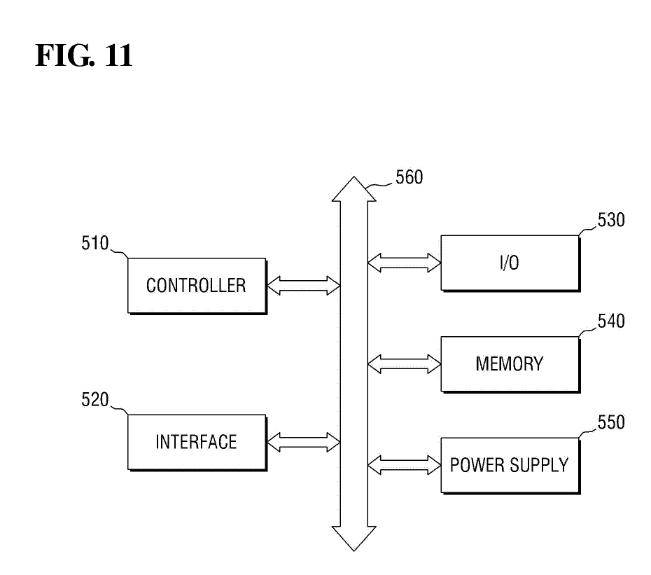

Referring to FIG. 11, the data deduplication apparatus according to various one or more example embodiments of the inventive concepts may include a controller 510, an interface 520, an input/output (I/O) device 530, a memory 540, a power supply 550, and a bus 560. For example, the data deduplication apparatus of FIG. 11 may implement the structures illustrated in FIG. 1 and/or FIG. 2 and may perform the operations described above with reference to FIGS. 9 and 10.

The controller 510, the interface 520, the I/O device 530, the memory 540, and the power supply 550 may be connected to each other through the bus 560. The bus 560 corresponds to paths through which data is transferred. The controller 510 may include at least one of a processor, a microprocessor, a microcontroller, and logic devices that can perform functions similar to the functions thereof to process data. The interface 520 may function to transfer data to a communication network or to receive the data from the communication network. The interface 520 may be of a wired or wireless type. For example, the interface 520 may include an antenna or a wire/wireless transceiver. The I/O device 530 may include a keypad and a display device to input/output data. The memory 540 may store data and/or commands. In some one or more example embodiments of the inventive concepts, the semiconductor device may be provided as a partial constituent element of the memory 540. The power supply 550 may convert a power input from an outside and provide the converted power to the respective constituent elements 510 to 540.

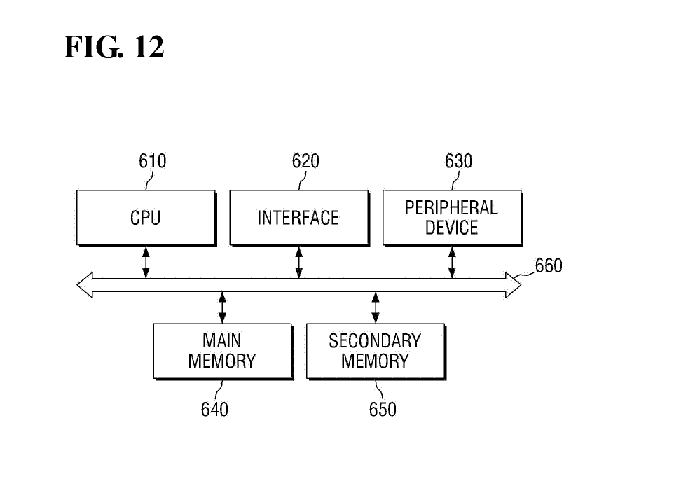

FIG. 12 is a schematic block diagram explaining an application example of a data deduplication apparatus the implements a data deduplication method according to at least one example embodiment of the inventive concepts. For example, the data deduplication apparatus of FIG. 12 may implement the structures illustrated in FIG. 1 and/or FIG. 2 and may perform the operations described above with reference to FIGS. 9 and 10.

Referring to FIG. 12, the data deduplication apparatus may include a central processing unit (CPU) 610, an interface 620, a peripheral device 630, a main memory 640, a secondary memory 650, and a bus 660.

The CPU 610, the interface 620, the peripheral device 630, the main memory 640, and the secondary memory 650 may be connected to each other through the bus 660. The bus 660 corresponds to paths through which data is transferred. The CPU 610 may include a controller, an arithmetic-logic unit, and the like, and may execute a program to process data. The interface 620 may function to transfer data to a communication network or to receive the data from the communication network. The interface 620 may be of a wired or wireless type. For example, the interface 620 may include an antenna or a wire/wireless transceiver. The peripheral device 630 may include a mouse, a keyboard, a display, and a printer, and may input/output data. The main memory 640 may transmit/receive data with the CPU 610, and may store data and/or commands that are required to execute the program. According to some one or more example embodiments of the inventive concepts, the semiconductor device may be provided as partial constituent elements of the main memory 640. The secondary memory 650 may include a nonvolatile memory, such as a magnetic tape, a magnetic disc, a floppy disc, a hard disk, or an optical disk, and may store data and/or commands. The secondary memory 650 can store data even in the case where a power of the electronic system is intercepted.

In addition, an electronic system that implements the data deduplication method according to some one or more example embodiments of the inventive concepts may be provided as one of various constituent elements of electronic devices, such as a computer, a UMPC (Ultra Mobile PC), a work station, a net-book, a PDA (Personal Digital Assistants), a portable computer, a web tablet, a wireless phone, a mobile phone, a smart phone, an e-book, a PMP (Portable Multimedia Player), a portable game machine, a navigation device, a black box, a digital camera, a 3-dimensional television receiver, a digital audio recorder, a digital audio player, a digital picture recorder, a digital picture player, a digital video recorder, a digital video player, a device that can transmit and receive information in a wireless environment, one of various electronic devices constituting a home network, one of various electronic devices constituting a computer network, one of various electronic devices constituting a telematics network, an RFID device, or one of various constituent elements constituting a computing system.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A data deduplication method comprising:
separating data into a plurality of data chunks that correspond to first to N-th positions, N being a positive integer that is greater than 1;
determining discrimination indexes of the first to N-th positions, respectively;
arranging the order of the first to N-th positions according to values of the discrimination indexes;
recording the arranged order of the first to N-th positions on a position vector; and
generating fingerprints through combination of the data chunks that correspond to the first to N-th positions according to the order of the first to N-th positions recorded on the position vector,
wherein the determining discrimination indexes includes determining the discrimination indexes according to a ratio of duplicate data chunks to the data chunks that correspond to a same position in a plurality of pieces of data.

2. The data deduplication method of claim 1, wherein the determining discrimination indexes includes,
determining a discrimination index, from among the discrimination indexes, to be higher as the ratio of the duplicate data chunks becomes lower, and
determining a discrimination index, from among the discrimination indexes, to be lower as the ratio of the duplicate data chunks becomes higher.

3. The data deduplication method of claim 1, wherein if a number of the duplicate data chunks among the data chunks that correspond to the first position from among the first to N-th positions in the plurality of pieces of data is smaller than a number of the duplicate data chunks among the data chunks that correspond to the second position from among the first to N-th positions, the determined discrimination index of the first position is higher than the determined discrimination index of the second position.

4. The data deduplication method of claim 1, wherein the position vector includes N elements that indicate the first to N-th positions, and
the generating fingerprints through combination of the data chunks that correspond to the first to N-th positions includes generating the fingerprints through combination of the data chunks that correspond to positions indicated by M elements based on the M elements among elements of the position vector, M being a positive integer that is less than N.

5. The data deduplication method of claim 4, further comprising:
increasing a value of M if a size of the plurality of pieces of data exceeds a preset upper limit value.

6. The data deduplication method of claim 4, further comprising:
decreasing a value of M if a size of the plurality of pieces of data is smaller than a preset lower limit value.

7. The data deduplication method of claim 1, wherein the plurality of pieces of data includes first data and second data, and
the data deduplication method further comprises:
determining whether the first data and the second data are duplicate data.

8. The data deduplication method of claim 7, wherein the generated fingerprints include fingerprints of the first and second data, respectively, and the determining whether the first data and the second data are duplicate data comprises:
determining whether the first data and the second data are duplicate data through comparison of the fingerprints of the first data and the second data with each other.

9. The data deduplication method of claim 8, wherein the determining whether the first data and the second data are duplicate data comprises:
increasing a length of the fingerprints of the first data and the second data based on the position vector if the fingerprints of the first data and the second data are equal to each other.

10. The data deduplication method of claim 7, wherein the determining whether the first data and the second data are duplicate data comprises:
determining whether the first data and the second data are duplicate data through comparison of the first data and the second data with each other in the unit of a data chunk according to the order of the first to N-th positions recorded on the position vector.

11. A data deduplication method comprising:
separating data, for which a storage operation is requested, into a plurality of data chunks that correspond to first to N-th (positions, respectively, N being a positive integer greater than 1;
determining discrimination indexes of the first to N-th positions, respectively;
arranging the order of the first to N-th positions according to values of the discrimination indexes;
recording the arranged order of the first to N-th positions on a position vector; and
generating fingerprints through combination of the data chunks that correspond to the first to N-th positions according to the order of the first to N-th positions recorded on the position vector,
wherein the determining discrimination indexes includes determining the discrimination indexes according to a ratio of duplicate data chunks to the data chunks that correspond to the same position in a plurality of pieces of data, and
a length of the fingerprints is varied according to a state of a storage unit in which the plurality of pieces of data are stored.

12. The data deduplication method of claim 11, further comprising:
increasing or decreasing the length of the fingerprints based on the position vector according to the state of the storage unit.

13. The data deduplication method of claim 12, wherein the increasing or decreasing the length of the fingerprints comprises:
increasing the length of the fingerprints based on the position vector if a size of the plurality of pieces of data stored in the storage exceeds a preset upper limit value.

14. The data deduplication method of claim 12, wherein the increasing or decreasing the length of the fingerprints comprises:
decreasing the length of the fingerprints if a size of the plurality of pieces of data stored in the storage is smaller than a preset lower limit value.

15. The data deduplication method of claim 12, wherein the increasing or decreasing the length of the fingerprints comprises:
increasing the length of the fingerprints of the first data and the second data based on the position vector if the fingerprint of the first data and the finger print of the second data are the same while the first data and the second data are different.

16. A data deduplication method comprising:
separating each of a plurality of data units into first to N-th data chunks,
the first to N-th data chunks being in first to N-th data positions, respectively, N being a positive integer that is greater than 1;
determining first to N-th discrimination indexes corresponding to the first to N-th data positions, respectively, such that, for each of the first to N-th discrimination indexes,
the discrimination index represents a degree of discrimination among first data chunks, first data chunks being data chunks, from among the first to N-th data chunks of the plurality of data units, that are in the data position to which the discrimination index corresponds;
arranging the order of the first to N-th positions according to values of the discrimination indexes;
storing the arranged order of the first to N-th positions as a position vector;
generating a plurality of fingerprints based on the position vector; and
determining whether a data unit is a duplicate of one of the plurality of data units based on the plurality of fingerprints.

17. The method of claim 16, wherein the generating a plurality of fingerprints includes generating the plurality fingerprints for the plurality of data units, respectively, such that, for each of the plurality of data units,
the fingerprint generated for the data unit is generated by combining first to M-th data chunks from among the first to N-th data chunks of the data unit, M being a positive integer less than N.

18. The method of claim 16, wherein,
the first to N-th discrimination indexes are determined according to first to N-th duplication ratios, respectively,
the first to N-th duplication ratios correspond to the first to N-th data positions, respectively, and
the first to N-th duplication ratios each represent a ratio of a number of duplicate data chunks to a total number of data chunks among the data chunks that are in the positions to which each of the first to Nth duplication ratios correspond, respectively,
each of the duplicate data chunks being a data chunk that stores first data and is in a data position, from among the first to N-th data position, in which another data chunk storing the same first data exists.
